(19) United States
(12) Patent Application Publication
(10) Pub. No.: US 2023/0348291 A1
(43) Pub. Date: Nov. 2, 2023

(54) METHOD FOR PREPARING SIZE-CONTROLLABLE METAL OXIDE TWO-DIMENSIONAL MATERIAL NANOSHEET

(71) Applicant: Shenzhen University, Shenzhen (CN)

(72) Inventor: Xingke Cai, Shenzhen (CN)

(21) Appl. No.: 17/984,865

(22) Filed: Nov. 10, 2022

(30) Foreign Application Priority Data
Apr. 27, 2022 (CN) 202210452265X

(51) Int. Cl. C01G 23/08

(52) U.S. Cl. CPC C01G 23/08; C01P 2004/24; C01P 2002/88; C01P 2004/62; C01P 2002/72; C01P 2004/03

(57) ABSTRACT

A method for preparing a size-changeable metal oxide two-dimensional material nanosheet is provided. The method includes the following steps: weighing a first original oxide mixture according to a ratio, grinding the first original oxide mixture, performing thermogravimetric analysis on the first original oxide mixture after the grinding to obtain a thermogravimetric curve, and designing a first-stage sintering temperature and a second-stage sintering temperature according to the thermogravimetric curve; preparing a second original oxide mixture with a weight of no more than one kilogram (kg) according to the ratio, and placing the second original oxide mixture into a heating device and performing heating at the first-stage sintering temperature and the second-stage sintering temperature, to obtain a metal oxide original layered material; and performing a protonophoric action and an organic base stripping on the metal oxide original layered material, to obtain the metal oxide two-dimensional material nanosheet.

### TECHNICAL FIELD

The present disclosure relates to the technical field of the preparation of a nanomaterial, and in particularly, to a method for preparing a size-controllable metal oxide two-dimensional material nanosheet.

### DESCRIPTION OF RELATED ART

The preparation and synthesis of a two-dimensional material is a hot research spot at present. Due to an ultra-thin structure and unique physicochemical properties of a two-dimensional material nanosheet, the two-dimensional material nanosheet has broad application prospects in many fields. Compared with methods for stripping the two-dimensional material, which are not exhaustive at present, there are few researches on controlling a growth size of the two-dimensional material. This is mainly because growth of the two-dimensional material is greatly affected by temperature and time, whereas these two variables are difficult to control during a growth process. Compared with a large-sized two-dimensional material nanosheet, the small-sized two-dimensional material nanosheet has more edge positions, and is widely used in catalysis, super capacitors and many other fields. At present, a size of a nanosheet obtained by the method for stripping the two-dimensional material cannot be effectively controlled, and the nanosheet can only be cut by a method such as cell crushing, which is complicated. Therefore, simplifying a process of preparing the two-dimensional material and controlling the growth size of the two-dimensional material are the focus and difficulty of research.

In addition, at present, many researches on the two-dimensional material are only limited to laboratories, and in the field of the two-dimensional material, only graphene has realized the industrialization of the two-dimensional material. Among currently known methods for the two-dimensional materials, there are few researches on large-scale preparation of the two-dimensional materials. This greatly limits the wide application of the two-dimensional material in the production and life. Further, preparing cost of the two-dimensional material is very expensive. A price of one kilogram of graphene oxide nanosheets sold in the known market is about 10,000 China yuan (CNY). At present, only the graphene has been industrialized, and an industrialized preparation method of the graphene cannot be adopted by other two-dimensional materials, thereby leading to a large gap in the practical application field of the two-dimensional material. Therefore, a low-cost kilogram-scale preparation of the two-dimensional material has an extremely important research significance.

### SUMMARY

In order to at least overcome defects in the related art, an objective of the present disclosure is to provide a method for preparing a size-controllable metal oxide two-dimensional material nanosheet. A specific technical solution is as follows.

An embodiment of the present disclosure provides a method for preparing a size-controllable metal oxide two-dimensional material nanosheet, including the following steps: weighing a first original oxide mixture according to a ratio, grinding the first original oxide mixture, performing thermogravimetric analysis on the first original oxide mixture after the grinding to obtain a thermogravimetric curve, and designing a first-stage sintering temperature and a second-stage sintering temperature according to the thermogravimetric curve; preparing a second original oxide mixture with a weight of no more than one kilogram (kg) according to the ratio, and placing the second original oxide mixture into a heating device and performing heating at the first-stage sintering temperature and the second-stage sintering temperature, to obtain a metal oxide original layered material; and performing a protonophoric action and an organic base stripping on the metal oxide original layered material, to obtain the metal oxide two-dimensional material nanosheet.

In an embodiment of the present disclosure, the first-stage sintering temperature includes 2 to 3 temperature sections; at the first-stage sintering temperature, a mass loss of the second original oxide mixture is in a range from 0.04 wt %/h to 50 wt %/h; the first-stage sintering temperature is in a range from 450° C. to 800° C.; and the second-stage sintering temperature is in a range from 800° C. to 900° C.

The first-stage and second-stage sintering temperatures have different functions. The first-stage sintering temperature is lower, so as to enable metal carbonate to discharge a gas slowly. In order to ensure that most of gas is discharged before heating at the second-stage sintering temperature, and to prevent explosion caused by excessive air pressure in a furnace during a final heating process, the first-stage sintering temperature usually includes 2 to 3 temperature sections, and slopes of thermogravimetric curves corresponding to different temperature sections is required to be moderate, that is, a speed of gas discharge is required to be moderate. The second-stage sintering temperature is higher for reaction to generate a layered oxide.

In an embodiment of the present disclosure, the heating device is a heating furnace having a maximum heating temperature being equal to or more than 800° C., for example, a muffle furnace.

In an embodiment of the present disclosure, during the heating, the method includes: after a heating process corresponding to one of the temperature sections of the first-stage sintering temperature is finished, taking out the second original oxide mixture after the heating process and performing grinding, and heating the second original oxide mixture after the grinding at another temperature section of the first-stage sintering temperature next to the one temperature section, so that the second original oxide mixture can react more fully in a subsequent sintering process; the second original oxide mixture after the grinding is weighed, and a discharge amount of carbon dioxide is calculated, so as to enable the reaction to be fully performed and the gas can be fully discharged.

In an embodiment of the present disclosure, a growth size of a two-dimensional nano-material is controlled by controlling the second-stage sintering temperature and a reaction time. If the second-stage sintering temperature is increased and the reaction time is prolonged, the two-dimensional nano-material finally obtained has a large size. On the contrary, if the second-stage sintering temperature is decreased and the reaction time is shorted appropriately, the two-dimensional nano-material finally obtained has a small size.

In an embodiment of the present disclosure, the heating device is connected to limewater. In the process of obtaining the metal oxide original layered material by high-temperature calcination, the gas produced is mainly carbon dioxide. In the process of low-temperature heating, the heating device is connected to the limewater via a ventilation pipe, so that a large amount of gas produced is treated, carbon emission is reduced, and the safety of the experimental process is increased. The ventilation pipe is for example a stainless steel ventilation pipe, which can withstand a high temperature gas generated in the muffle furnace, and the ventilation pipe is long enough to be connected to the lime water.

In an embodiment of the present disclosure, performing the protonophoric action and the organic base stripping on the metal oxide original layered material specifically includes: adding acid into the metal oxide original layered material for replacing, separating out a powder from the metal oxide original layered material after the replacing, adding an organic base into the powder, and adding water into the powder, to thereby obtain a solution, where the powder is uniformly distributed into the solution.

In an embodiment of the present disclosure, the performing the protonophoric action and the organic base stripping further includes a mechanical stirring, such as mechanical stirring by a Teflon stirrer; and a speed of the mechanical stirring is in a range from 100 revolutions per minute (rpm) to 2000 rpm, so that the mixture can react fully and quickly through stirring.

In an embodiment of the present disclosure, a time of the protonation action is in range from 1 day to 7 days, and a time of the organic base stripping is in a range from 1 day to 7 days.

In order to make the reaction more complete, the time of the protonation action and the time of the organic base stripping can be prolonged correspondingly.

In a preferable embodiment of the present disclosure, adding the acid into the metal oxide original layered material for replacing specifically includes: adding the acid into the metal oxide original layered material for replacing every day.

In a preferable embodiment of the present disclosure, a concentration of the powder of the solution is in a range from 0.01 milligrams per milliliter (mg/ml) to 100 mg/ml.

In a preferable embodiment of the present disclosure, during the protonophoric action, a concentration of the acid is in a range from 0.1 moles per liter (mol/L) to 5 mol/L, and the acid is one selected from the group consisting of hydrochloric acid, nitric acid, sulfuric acid, and phosphoric acid. In order to have enough hydrogen ions to replace the protons in the metal oxide original layered material, the acid is added for replacing every day, so as to ensure that there are enough hydrogen ions for protonation. After the protonation, the powder is separated out by filtering or standing to remove impurity ions in the metal oxide original layered material and make the product more pure.

In an embodiment of the present disclosure, the organic base is tetrabutylammonium hydroxide or tetramethylammonium hydroxide; and the organic base is added according to a molar mass ratio of hydroxide and hydrogen ions of the metal oxide original layered material after the protonophoric action, so as to ensure sufficient stripping and uniform dispersion of nano-sheets.

In an embodiment of the present disclosure, the metal oxide original layered material is a layered metal oxide containing an alkali metal and an alkaline earth metal; and the metal oxide original layered material includes at least one of lithium potassium titanate (K_{0.8}Ti_{1.73}Li_{0.27}O₄), lithium potassium titanium ironate (K_{0.8}Ti_{(5.2-2x)/3}Li_{(0.8-x)/3}FeₓO₄), potassium lithium titanocobaltate (K_{0.8}Ti_{(5.2-y)/3}Li_{(0.8-2y)/3}Co_{y}O₄), potassium calcium niobate (KCa₂Nb₃C₁₀), potassium calcium sodium niobate, sodium cobaltate (KNa_{X}Ca₂Nb₃₊ₓO₁₀), cobalt sodium manganite (NaCoₓMn₁₋ₓO₂), and potassium cesium tungstate (Cs₆₊ₓW₁₁O₃₆).

In an embodiment of the present disclosure, the metal oxide two-dimensional material nanosheet includes at least one of a titanium-iron-oxygen two-dimensional material nanosheet, a titanium oxide two-dimensional material nanosheet, a manganese oxide two-dimensional material nanosheet, a cobalt-manganese-oxygen two-dimensional material nanosheet, and a calcium niobate two-dimensional material nanosheet.

In an embodiment of the present disclosure, a particle size of the metal oxide two-dimensional material nanosheet is in a range from 500 (nanometers) nm to 800 nm.

In an embodiment of the present disclosure, the metal oxide two-dimensional material nanosheet is a titanium oxide two-dimensional material nanosheet; the first-stage sintering temperature includes two temperature sections, the two temperature sections are 650° C. and 750° C., and the second-stage sintering temperature is 800° C.; and performing heating at the first-stage sintering temperature and the second-stage sintering temperature specifically includes: heating at a heating temperature of 650° C. for a heating time of 5 h, heating at a heating temperature of 750° C. for a heating time of 4 h, and heating at a heating temperature of 800° C. for a heating time of 2-14 h.

The present disclosure has at least following beneficial effects.

1. With respect to the method for preparing the size-controllable metal oxide two-dimensional material nanosheet of the embodiments of the present disclosure, the heating temperatures and heating times of staged sintering processes are set by observing a thermogravimetric curve of the original oxide, a metal oxide original layered material is obtained through the staged sintering processes, then a two-dimensional metal oxide nanosheet is finally obtained through a protonophoric action and an organic base stripping, a size range of the two-dimensional metal oxide nanosheet is 500-800 nm. A layered structure and a crystal structure of the two-dimensional metal oxide nanosheet are kept in good condition. A special heat treatment manner adopt by the method of the present disclosure enables the generate gas such as carbon dioxide to be effectively treated, a mount of a remaining gas of which is lower than that of a traditional one-step high-temperature synthesis method. A size of the final metal oxide original layered material can be controllably prepared from a small size to a large size. A two-dimensional material with a controllable size can be prepared only by controlling the heating temperatures and the heating times, so that the operation is simple.

In the method of the present disclosure, the protonophoric action and the organic base stripping are performed by adopting the mechanical stirring, so that the defect that a traditional magnetic stirring and oscillation method is only suitable for small batches in a laboratory is overcome, and batch kilogram-scale preparation of the two-dimensional material is realized. The method of the present disclosure can be widely used in the fields of catalysis, energy, environmental protection and the like, as well as a production and life.

2. According to the embodiments of the present disclosure, a high efficiency and a high yield of the preparation of the two-dimensional material nanosheet are realized, and compared with the graphene which has been industrialized, the cost of the method of the present disclosure is lower, and the prepared two-dimensional material nanosheet has the same excellent photochemical property as the graphene. The two-dimensional material nanosheet has great potential in the industrial application of the two-dimensional material, such as in the fields of catalysis, composite materials, energy storage and the like.

3. In the embodiments of the present disclosure, a two-dimensional material nanosheet is prepared by means of multi-stage temperature control, and gas is discharged at a low temperature, and a layered material is generated through sintering at a high temperature, which can prevent a high pressure caused by a large amount of gas generated in a synthesis process from causing high pressure to cause a frying furnace, thereby achieving higher safety.

### BRIEF DESCRIPTION OF THE DRAWINGS

FIG. 1 illustrates a total thermogravimetric curve of a mixture of a first embodiment.

FIG. 2 illustrates thermogravimetric curves of the mixture of the first embodiment at different temperatures.

FIG. 3a through FIG. 3c illustrate a test comparison of X-ray diffraction (XRD) data of an original layered material at different times of sintering of a second embodiment and a standard XRD data card.

FIG. 4a through FIG. 4c illustrate scanning electron microscope (SEM) images of small-sized two-dimensional titanium oxide nanosheets prepared at different heating times.

FIG. 5a through FIG. 5f illustrate XRD data and particle size analyzer data of small-sized two-dimensional titanium oxide nanosheets prepared at different heating times.

FIG. 6 illustrates a two-dimensional material prepared in a third embodiment, in which a refers to an optical image of an iron-doped titanium oxide nanosheet solution, and b refers to a transmission electron microscope image of an iron-doped titanium oxide nanosheet.

### DETAILED DESCRIPTION OF EMBODIMENTS

In order to understand the present disclosure more clearly, the present disclosure will be further described with reference to following embodiments and accompanying drawings. The embodiments are for illustration merely and do not limit the present disclosure in any way. In the embodiments, materials of all the original reagent are commercially available, and experimental methods without specific conditions are done by conventional methods and conditions well known in the art, or according to conditions suggested by corresponding instrument manufacturers.

According to the present disclosure, firstly, staged sintering temperatures of staged sintering processes are set by referring to a thermogravimetric curve of a mixture. Because each of different metal oxides has a melting point, which is constant, the mixture composed of the different metal oxides will have different degrees of quality loss at different temperatures. By observing the thermogravimetric curve of the mixture from 100° C. to 1000° C., a temperature with moderate slope of the curve, that is, the temperature with a moderate gas emission rate in a heating process, is selected, and an appropriate heating time is set. Then, the mixture is put into a muffle furnace for calcination with pre-set temperature sections. Preferably, after a sintering process corresponding to each temperature section of the pre-set temperature sections is finished, the mixture is taken out and fully grinded, in order to enable the subsequent reaction to be more complete; a loss of solid mass is calculated to observe a gas discharge, based on this, a subsequent temperature section and a subsequent heating time are appropriately adjusted to keep the temperature as low as possible and keep the heating time as short as possible. Finally, an ideal small-sized layered material of the two-dimensional material is obtained. Then, dilute hydrochloric acid is used to replace the obtained layered material, the hydrochloric acid is added every day for three days to obtain a protonated solution, then the protonated solution is added into water for centrifugation to obtain a precipitate, and the obtained precipitate is continuously washed and centrifuged. Then, a tetrabutylammonium hydroxide solution (TBAOH, 40%) is added according to a molar mass ratio of hydroxide and hydrogen ions of the protonated material to obtain a solution, and then a certain volume of water is added to make nanosheets be evenly distributed in the solution. Then, the solution is put into a Teflon stirrer for stirring, and finally an ideal small-sized nanosheet is obtained.

In order to make the size of nanosheet to be small and adjustable, parameters such as a temperature and a heating time and a solvent ratio are explored and optimized. Taking the preparation of small-sized titanium oxide nanosheet as an example, the technical solution of the present disclosure is explained in detail.

### First Embodiment

Multiple parts of original mixture (i.e. a titanium oxide (TiO₂) precursor) are prepared using potassium carbonate, lithium carbonate and titanium dioxide in a mass ratio of 2.4:0.81:10.36, each original mixture is 1 kilogram (kg) and is mixed evenly. A small amount of the original mixture is taken out to obtain a thermogravimetric curve of the original mixture, and to plan temperature sections.

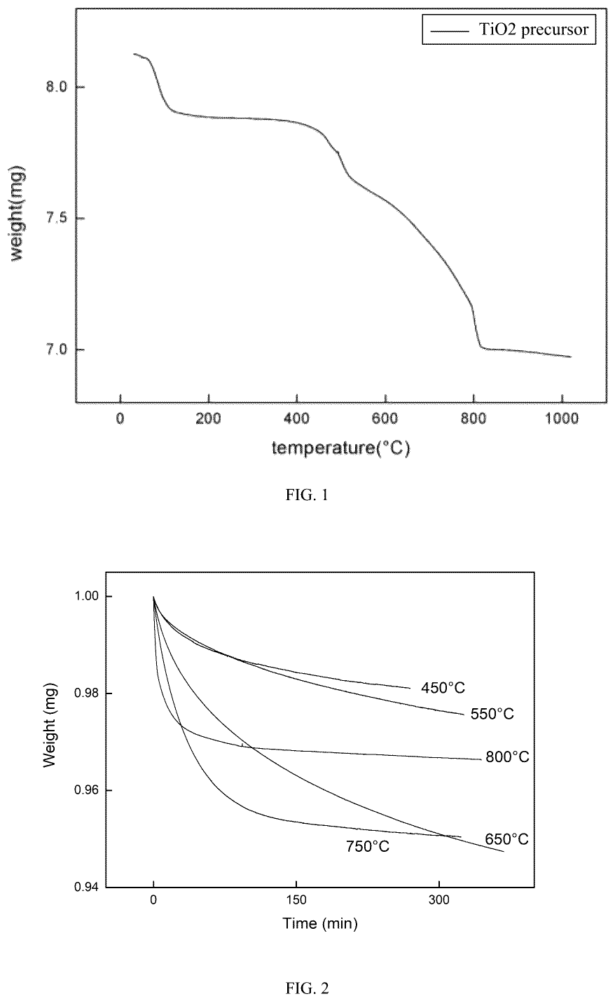

A total thermogravimetric curve of the original mixture is shown in FIG. 1, and thermogravimetric curves of the original mixture at different temperatures are shown in FIG. 2.

### Second Embodiment

On the basis of the first embodiment, three parts of 1 kg original mixture (1 kg per part) are taken for three groups of experiments, and the following operations are performed respectively.

Each of the three parts of 1 kg original mixture is processed as follows to obtain three parts of processed original mixture: putting the 1 kg original mixture into a muffle furnace for a first sintering with a heating temperature of 650° C. and a heating time of 5 hours (h); taking out the original mixture after the first sintering and performing a first grinding, to discharge a residual gas in the original mixture; putting the original mixture after the first grinding into the muffle furnace again for a second sintering with a heating temperature of 750° C. and a heating time of 4 hours; taking out the original mixture after the second sintering and performing a second grinding, to discharge a residual gas in the original mixture, and thus obtain a processed original mixture, i.e., one part of the three parts of processed original mixture. The three parts of processed original mixture are each put into the muffle furnace for a third sintering with a heating temperature of 800° C., heating times are designed to be 2 h, 10 h and 14 h, respectively, and three parts of original two-dimensional layered material are obtained. Then, the three parts of original two-dimensional layered material are each processed as follows to obtain three parts of protonated layered material: adding 500 milliliters (mL) of hydrochloric acid with a concentration of 1 moles per liter (mol/L) for acidification for 7 days which including adding the hydrochloric acid every day for replacing, performing a filtering process to separate out powder therein, and thus to obtain a protonated layered material, i.e., one part of the three parts of protonated layered material. Then, the three parts of protonated layered material are each processed to obtain three parts of two-dimensional titanium oxide nanosheets: adding the protonated layered material into 4.2 L of a TBAOH solution (added according to a molar mass ratio of hydroxide and hydrogen ions of the protonated layered material), and then adding 5.8 L of water (into a corresponding container) for proportioning, so that nanosheets are evenly distributed in the solution, placing the solution in a Teflon stirrer for mechanical stirring at a speed of 100 revolutions per minute (rpm) for stripping, and finally obtaining two-dimensional titanium oxide nanosheets, i.e., one part of the three parts of two-dimensional titanium oxide nanosheets.

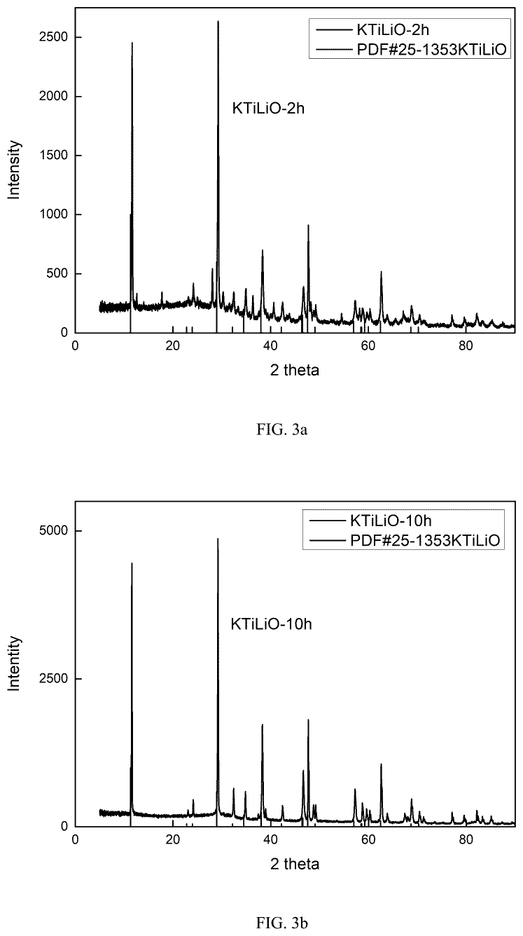

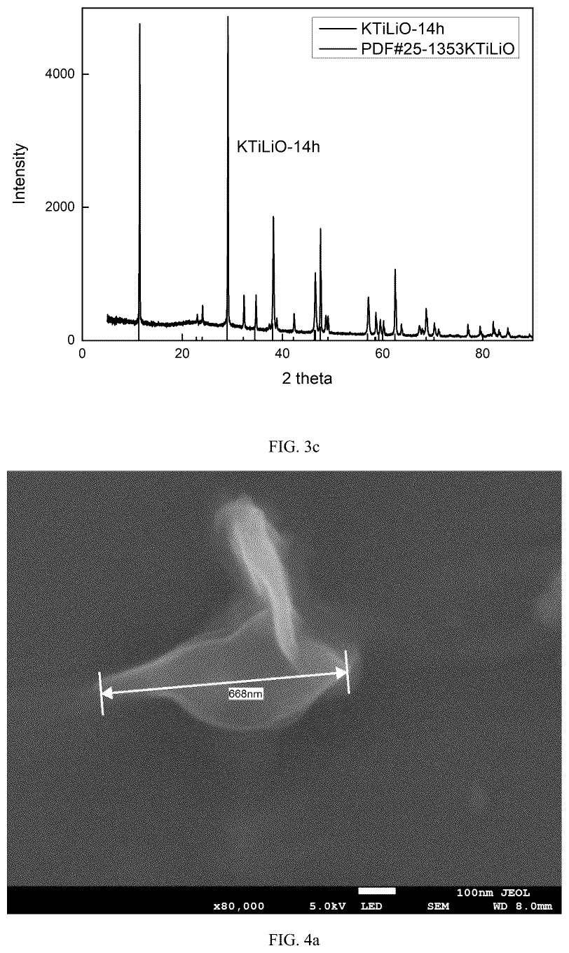

A test comparison of XRD data between of three parts of original two-dimensional layered materials at different heating times and a standard XRD data card (shown as PDF #25-1353KTiLiO) is shown in FIG. 3a through FIG. 3c.

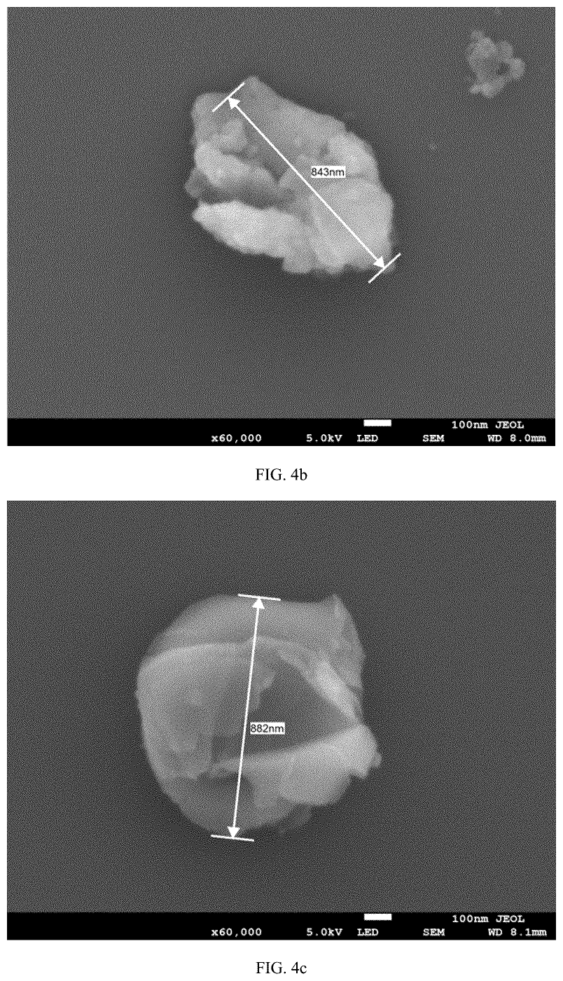

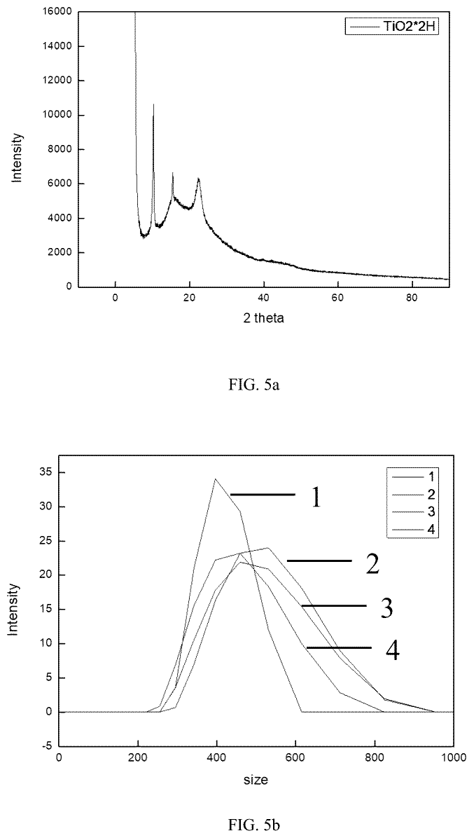

SEM images of small-sized two-dimensional titanium oxide nanosheets prepared at different heating times are shown in FIG. 4a through FIG. 4c, and the sintering times are 2 h, 10 h and 14 h respectively from top to bottom.

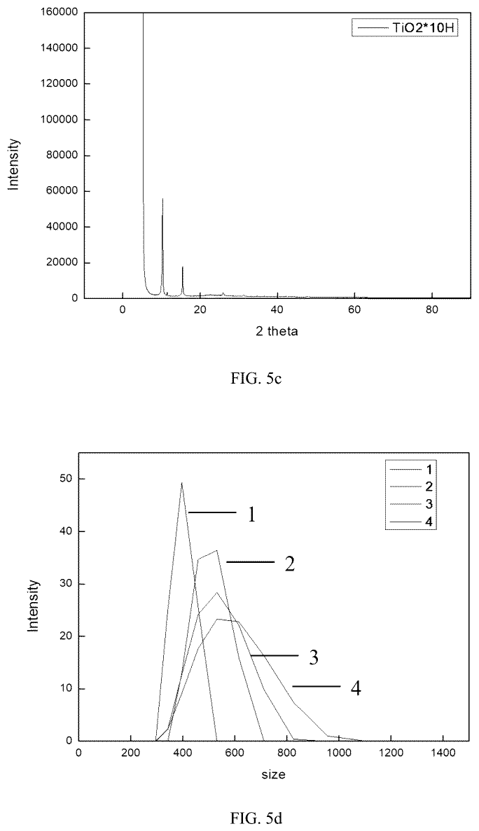

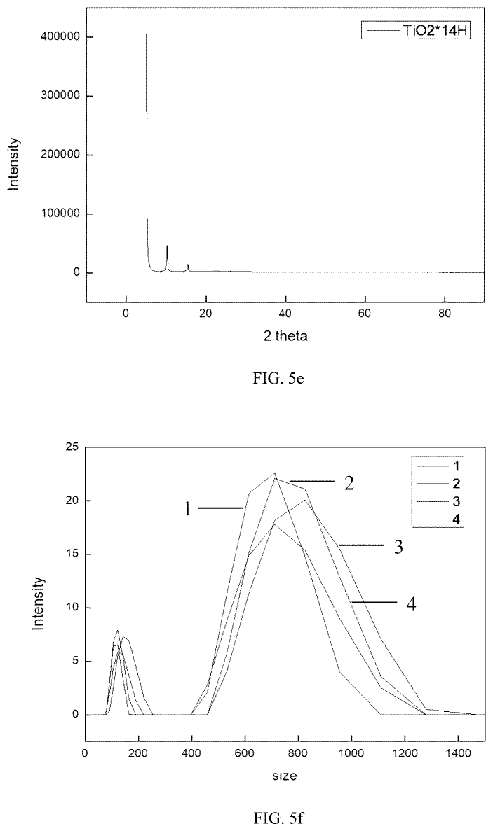

XRD data and particle size analyzer data of the two-dimensional titanium oxide nanosheet obtained by stripping the small-sized precursors prepared at different heating times are shown in FIG. 5a through FIG. 5f, in which numbers 1, 2, 3, and 4 in each of FIGS. 5b, 5d, and 5f represent data of four tests, respectively.

### Third Embodiment

Based on the second embodiment, a concentration of the solution is designed in the stripping of an organic base, and the added water volumes are 2 L, 4 L and 8 L, respectively. Other steps in the third embodiments are the same as in the second embodiments. Finally, two-dimensional materials are successfully prepared.

### Fourth Embodiment

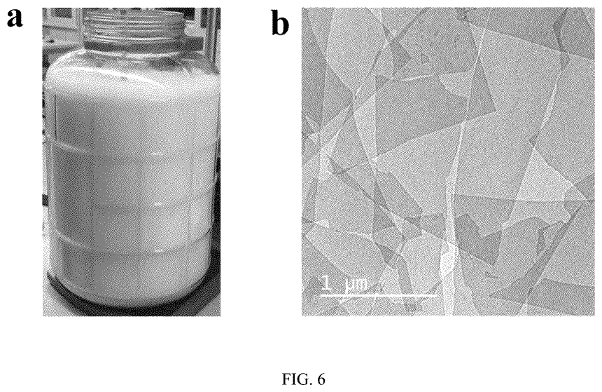

Based on the first and second embodiments, in the third embodiment, experiments are performed on the preparation of different two-dimensional metal oxides, and titanium dioxide, iron oxide and potassium carbonate are selected as raw materials for the experiments. Finally, a large number of two-dimensional materials can be obtained, as shown in FIG. 6.

It is apparent that the above-mentioned embodiments are merely examples for clear explanation, but not limitations on the embodiments. For those of ordinary skill in the art, other changes or variations can be made on the basis of the above description. It is not necessary and impossible to discharge all the embodiments herein. However, the obvious changes or variations derived therefrom are still within the scope of protection created by the present disclosure.

What is claimed is:

1. A method for preparing a metal oxide two-dimensional material nanosheet, comprising the following steps:
weighing a first original oxide mixture according to a ratio, grinding the first original oxide mixture, performing thermogravimetric analysis on the first original oxide mixture after the grinding to obtain a thermogravimetric curve, and designing a first-stage sintering temperature and a second-stage sintering temperature according to the thermogravimetric curve;
preparing a second original oxide mixture with a weight of no more than one kilogram (kg) according to the ratio, and placing the second original oxide mixture into a heating device and performing heating at the first-stage sintering temperature and the second-stage sintering temperature, to obtain a metal oxide original layered material; and
performing a protonophoric action and an organic base stripping on the metal oxide original layered material, to obtain the metal oxide two-dimensional material nanosheet.

2. The method of claim 1, wherein the first-stage sintering temperature comprises 2 to 3 temperature sections;
wherein at the first-stage sintering temperature, a mass loss of the second original oxide mixture is in a range from 0.04 wt %/h to 50 wt %/h;
wherein the first-stage sintering temperature is in a range from 450° C. to 800° C.; and
wherein the second-stage sintering temperature is in a range from 800° C. to 900° C.

3. The method according to claim 2, wherein the method further comprises:
after a heating process corresponding to one of the temperature sections of the first-stage sintering temperature is finished, taking out the second original oxide mixture after the heating process and performing grinding, and heating the second original oxide mixture after the grinding at another temperature section of the first-stage sintering temperature next to the one temperature section.

4. The method according to claim 1, wherein the heating device is a heating furnace having a maximum heating temperature being equal to or more than 800° C.; and
wherein the heating device is connected to limewater.

5. The method according to claim 1, wherein performing the protonophoric action and the organic base stripping on the metal oxide original layered material specifically comprises:
adding acid into the metal oxide original layered material for replacing, separating out a powder from the metal oxide original layered material after the replacing, adding an organic base into the powder, and adding water into the powder, to thereby obtain a solution, wherein the powder is uniformly distributed into the solution;
wherein the performing the protonophoric action and the organic base stripping further comprises a mechanical stirring;
wherein a speed of the mechanical stirring is in a range from 100 revolutions per minute (rpm) to 2000 rpm;
wherein a time of the protonation action is in range from 1 day to 7 days, and a time of the organic base stripping is in a range from 1 day to 7 days;
wherein adding the acid into the metal oxide original layered material for replacing specifically comprises:
adding the acid into the metal oxide original layered material for replacing every day; and
wherein a concentration of the powder of the solution is in a range from 0.01 milligrams per milliliter (mg/ml) to 100 mg/ml.

6. The method according to claim 5, wherein a concentration of the acid is in a range from 0.1 moles per liter (mol/L) to 5 mol/L, and the acid is one selected from the group consisting of hydrochloric acid, nitric acid, sulfuric acid, and phosphoric acid;
wherein the organic base is tetrabutylammonium hydroxide (TBAOH) or tetramethylammonium hydroxide; and
wherein the organic base is added according to a molar mass ratio of hydroxide and hydrogen ions of the metal oxide original layered material after the protonophoric action.

7. The method according to claim 1, wherein the metal oxide original layered material is a layered metal oxide containing an alkali metal and an alkaline earth metal; and
wherein the metal oxide original layered material comprises at least one of lithium potassium titanate, lithium potassium titanium ironate, potassium lithium titanocobaltate, potassium calcium niobate, potassium calcium sodium niobate, sodium cobaltate, cobalt sodium manganite, and potassium cesium tungstate.

8. The method according to claim 1, wherein the metal oxide two-dimensional material nanosheet comprises at least one of a titanium-iron-oxygen two-dimensional material nanosheet, a titanium oxide two-dimensional material nanosheet, a manganese oxide two-dimensional material nanosheet, a cobalt-manganese-oxygen two-dimensional material nanosheet, and a calcium niobate two-dimensional material nanosheet.

9. The method according to claim 1, wherein a particle size of the metal oxide two-dimensional material nanosheet is in a range from 500 (nanometers) nm to 800 nm.

10. The method according to claim 1, wherein the metal oxide two-dimensional material nanosheet is a titanium oxide two-dimensional material nanosheet;
wherein the first-stage sintering temperature comprises two temperature sections, the two temperature sections are 650° C. and 750° C., and the second-stage sintering temperature is 800° C.; and
wherein performing heating at the first-stage sintering temperature and the second-stage sintering temperature specifically comprises:
heating at a heating temperature of 650° C. for a heating time of 5 h, heating at a heating temperature of 750° C. for a heating time of 4 h, and heating at a heating temperature of 800° C. for a heating time of 2-14 h.
